(19) United States
(12) Patent Application Publication
(10) Pub. No.: US 2005/0015728 A1
(43) Pub. Date: Jan. 20, 2005

(54) Method, system, and program product for customizing a user interface

(75) Inventors: Richard W. Ragan JR., Round Rock, TX (US); Wayne B. Riley, Cary, NC (US)

Correspondence Address: Gerald R. Woods;IBM Corporation T81/503, PO Box 12195, Research Triangle Park, NC, 27709, US

(73) Assignee: International Business Machines Corporation, Armonk, NY (US)

(21) Appl. No.: 10/621,289

(22) Filed: Jul. 17, 2003

(51) Int. Cl. G09G 5/00

(52) U.S. Cl. 715/765; 715/811; 715/821; 715/847

(57) ABSTRACT

Method, system, and program product for customizing a user interface. The user interface is adjusted by including a shortcut for one or more object operations. Each shortcut is selected based on a user, an object being displayed in the user interface, and/or a history of object operations. The selection can be based on the frequency that the user has previously selected object operations for the object.

### BACKGROUND OF THE INVENTION

1. Technical Field

The invention relates generally to user interfaces, and more specifically to a solution for automatically customizing a user interface based on an object, object attributes (such as state, status, etc.), and/or a user.

2. Related Art

Most user interfaces are standardized and do not differ from user to user, while some user interfaces can be customized by the user. For example, some applications allow buttons that appear on a tool bar to be manually added or removed. Further, the user can select whether the tool bar should be displayed at all. However, these changes often impact all users of the application, and require that the user take the time to specifically adjust the tool bar to appear as desired. Moreover, many users are not aware of their ability to make these customizations, forget how to perform the customization, or simply do not want to take the time to adjust the buttons. In any case, users are required to spend additional time either customizing the tool bar, or locating frequently used operations that are not present on the tool bar through, for example, one or more menus and/or dialogs. Should a user's job change, the operations frequently performed may also change. With current applications, the user would be required to customize the user interface to reflect the changed operations. Further, these user customizations impact the user interface regardless of a context (e.g., read only or read/write) of an object being displayed. The user interface always presents the customizations to the user who must then decide what actions are appropriate.

Some applications have sought to ease the use of a menu by purging options from the menu that are not frequently used. As a result, the user is presented with a smaller list that is easier to navigate. However, this solution is problematic when an option being sought has been purged. In this case, the user must perform some action to make the option reappear, causing additional frustration.

Additionally, current solutions fail to account for different users of the interface and/or different objects that may be operated on using the interface. As a result, a need exists for a method, system, and program product that automatically adjust a user interface based on a user, an object, and/or object attributes (such as state, status, etc.).

### SUMMARY OF THE INVENTION

The invention provides a method, system, and program product for automatically customizing a user interface based on a user, an object, and/or a history of object operations. In one embodiment, a history of object operations is updated each time the user selects an object operation. One or more shortcuts are displayed based on the history of object operations. For example, a portion of the user interface can be reserved to display buttons that provide efficient access to object operations. Certain buttons are selected for display based on the history of object operations. As such, the buttons can be displayed based on a history of object operations selected by the user or a group of users, and/or a history of object operations performed on the object or a group of objects. When multiple shortcuts are displayed, they can be ordered such that the shortcut for the most frequently selected object operation is placed in the most convenient location.

A first aspect of the invention provides a method of customizing a user interface, the method comprising: identifying a user of the user interface; displaying an object within the user interface; and displaying a shortcut for the object based on the user and a history of object operations performed by the user.

A second aspect of the invention provides a method of customizing a user interface, the method comprising: identifying a user of the user interface; displaying an object within the user interface, wherein the object has an object attribute; recording object operations that are performed by the user on the object in a history of object operations; and displaying a shortcut for the object based on the user, the object attribute, and the history of object operations.

A third aspect of the invention provides a system for customizing a user interface, the system comprising: an identification system for identifying a user of the user interface; a display system for displaying an object in the user interface; a recording system for recording object operations that are selected by the user; and a customization system for displaying a shortcut for an object operation based on the recorded object operations and the object.

A fourth aspect of the invention provides a program product stored on a recordable medium for customizing a user interface, which when executed comprises: program code for identifying a user of the user interface; program code for displaying an object in the user interface; program code for recording object operations that are selected by the user; and program code for displaying a shortcut for an object operation based on the recorded object operations and the user.

The illustrative aspects of the present invention are designed to solve the problems herein described and other problems not discussed, which are discoverable by a skilled artisan.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts an illustrative system according to one aspect of the invention;

FIG. 2 depicts an illustrative user interface according to another aspect of the invention; and

FIG. 3 depicts illustrative user entries according to yet another aspect of the invention.

It is noted that the drawings of the invention are not to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

The invention provides a method, system, and program product for automatically customizing a user interface based on a user, an object, and/or a history of object operations. In one embodiment, a history of object operations is updated each time the user selects an object operation. One or more shortcuts are displayed based on the history of object operations. For example, a portion of the user interface can be reserved to display buttons that provide efficient access to object operations. Certain buttons are selected for display based on the history of object operations. As such, the buttons can be displayed based on a history of object operations selected by the user or a group of users, and/or a history of object operations performed on the object or a group of objects. When multiple shortcuts are displayed, they can be ordered such that the shortcut for the most frequently selected object operation is placed in the most convenient location.

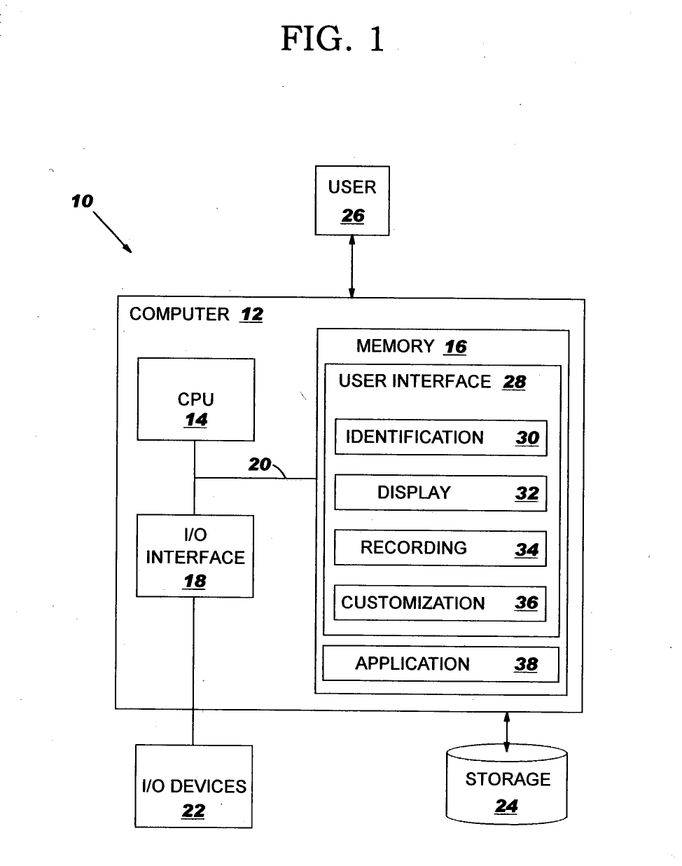

Turning to the drawings, FIG. 1 shows a computerized user interface customization system 10 for automatically customizing a user interface for user 26. User interface customization system 10 includes a computer 12 that comprises any type of computer. For example, computer 12 can be a hand-held device (e.g., personal digital assistant, cellular phone, pager device, etc.) or a larger-sized computer system (e.g., laptop, personal computer, workstation, server, etc.). In any event, user 26 can customize a user interface by interacting with computer 12.

As shown, computer 12 generally includes central processing unit (CPU) 14, memory 16, input/output (I/O) interface 18, bus 20, external I/O devices/resources 22, and a storage unit 24. CPU 14 may comprise a single processing unit, or be distributed across one or more processing units in one or more locations, e.g., on a client and server. Memory 16 may comprise any known type of data storage and/or transmission media, including magnetic media, optical media, random access memory (RAM), read-only memory (ROM), a data cache, a data object, etc. Storage unit 24 may comprise any type of data storage for providing more static storage of data used in the present invention. As such, storage unit 24 may include one or more storage devices, such as a magnetic disk drive or an optical disk drive. Moreover, similar to CPU 14, memory 16 and/or storage unit 24 may reside at a single physical location, comprising one or more types of data storage, or be distributed across a plurality of physical systems in various forms. Further, memory 16 and/or storage unit 24 can include data distributed across, for example, a LAN, WAN or a storage area network (SAN) (not shown).

I/O interface 18 may comprise any system for exchanging information to/from one or more I/O devices 22. I/O devices 22 may comprise any known type of external device, including speakers, a CRT, LED screen, hand-held device, keyboard, mouse, voice recognition system, speech output system, printer, monitor/display, facsimile, pager, etc. To this extent, it should be appreciated that if computer 12 is a hand-held device, the display would be contained within computer 12, and not as an external I/O device 22 as shown.

Bus 20 provides a communication link between each of the components in computer 12 and likewise may comprise any known type of transmission link, including electrical, optical, wireless, etc. In addition, although not shown, additional components, such as cache memory, communication systems, system software, etc., may be incorporated into computer 12.

Shown in memory 16 is a user interface system 28, and an application 38. User interface system 28 is shown including an identification system 30, a display system 32, a recording system 34, and a customization system 36. Operation of the various systems will be described below. While various systems are shown implemented as part of user interface system 28, it is understood that some or all of the systems can be implemented independently, combined, and/or stored in memory for one or more separate computers 12 that communicate over a network. In this case, the network can comprise any type of network including the Internet, a wide area network (WAN), a local area network (LAN), a virtual private network (VPN), etc. To this extent, communication can occur via a direct hardwired connection (e.g., serial port), or via an addressable connection in a client-server (or server-server) environment that may utilize any combination of wireline and/or wireless transmission methods. In the case of the latter, the server and client may utilize conventional network connectivity, such as Token Ring, Ethernet, WiFi or other conventional communications standards. Where the client communicates with the server via the Internet, connectivity could be provided by conventional TCP/IP sockets-based protocol. In this instance, the client would utilize an Internet service provider to establish connectivity to the server.

User interface customization system 10 automatically customizes a user interface that is rendered by user interface system 28 for user 26. The user interface is customized based on user 26, an object being displayed, and/or a history of object operations. It is understood that user interface system 28 can comprise any existing system for rendering a user interface. In this case, some or all of the functionality discussed herein can supplement the functionality provided by the existing user interface system. Alternatively, user interface system 28 can comprise a newly developed system that incorporates some or all of the functionality described herein.

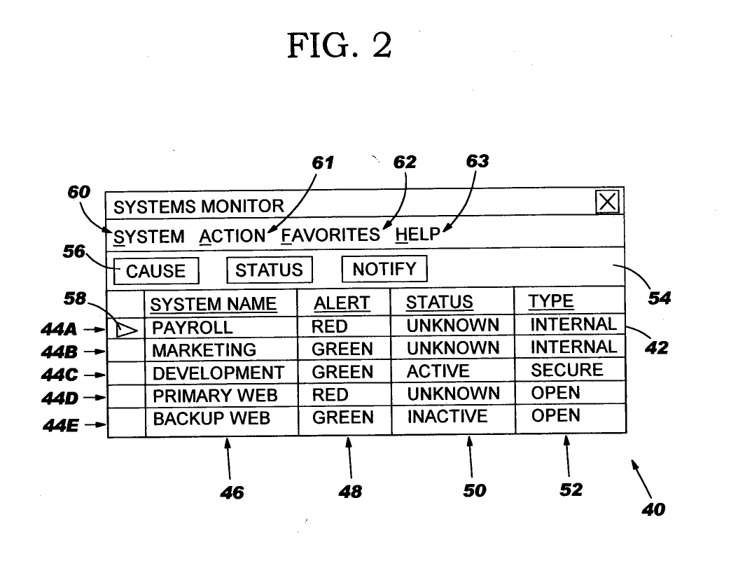

FIG. 2 depicts an illustrative user interface 40 (as rendered by user interface system 28 (FIG. 1)) that can be customized according to the present invention. Specifically, display system 32 (FIG. 1) displays one or more objects in a display area 42 of user interface 40. An “object” is defined broadly as any set of related data. As used throughout the application, the term “set” is used to denote one or more items. Typical objects comprise a data file (e.g., a word processor document, a spreadsheet, etc.), a set of related data within a data file (e.g., a section of a word processor document, a row on a spreadsheet, etc.), a group of related entries stored in a database, etc. For example, display area 42 of user interface 40 displays data for various “business” systems 44A-E (i.e., payroll, marketing, development, primary web, backup web). In this case, the data for each system 44A-E (e.g., each row in user interface 40) can comprise an object. Each object can include one or more object attributes. For example, when systems 44A-E each comprise an individual object, the object attributes include a system name 46, an alert 48, a status 50, and a type 52. Alternatively, when objects comprise data files, an object attribute may comprise a template that was used to provide default formatting for the file. For example, a word processor may have a “memo” template and a “purchase order” template.

To customize user interface 40, user 26 (FIG. 1) is identified using identification system 30 (FIG. 1). The user can be identified using any solution now known or later developed. For example, the user may be prompted to supply a user name and/or password before user interface 40 is rendered. Alternatively, the user may be identified when first accessing computer 12 (FIG. 1), and his/her identification can be automatically used by identification system 30 (FIG. 1). In addition, each user may have one or more user attributes. For example, a user may belong to a group of users having similar responsibilities (e.g., management, operator, marketing, etc.). The group in which a particular user belongs can be stored as a “user attribute” of the user. User attributes can also include various user preferences (e.g. customizations) such as display options, a privilege level for the user, a preferred shortcut format (e.g., button vs. menu), etc.

When multiple objects can be displayed simultaneously, user interface 40 typically includes some indication of a selected object. For example, user interface 40 could include a selection indicator 58 that indicates that system 44A is the current selection. It is understood that any solution for indicating current selection(s) can be incorporated in user interface 40. Further, user interface 40 provides a method of selecting object operations for the selected object. For example, menus 60, 61 can include a list of all possible object operations that may be performed on systems 44A-E. Depending on the selected system and its associated object properties, some of the object operations may be disabled. As a result, a user can select one or more object operations to perform on the selected object by using menus 60, 61. Further, a menu 63 can be included that allows a user to obtain help on how to use user interface 40. It is understood that various other solutions are possible. For example, user interface 40 can present a “pop up menu” when a user clicks a right mouse button.

In the present invention, one or more shortcuts for an object are displayed using customization system 36 (FIG. 1) based on the user, the object, and/or a history of object operations. As known, a shortcut provides a more direct method of implementing a function. For example, rather than accessing menus 60, 61 to perform an operation, user 26 (FIG. 1) can be provided with a more direct method of performing some or all of the object operations included in menus 60, 61. A shortcut can comprise, for example, a button, an icon, a toolbar control, a menu item, a hyperlink, etc. In one embodiment, user interface system 28 (FIG. 1) reserves a portion 54 of display area 42 in user interface 40 for displaying one or more buttons 56. Each button 56 is then displayed in portion 54. Further, user interface 40 can include a menu 62 that includes the frequently selected object operations. Selections on menu 62 can be added, rearranged (reordered), and/or removed based on the selected system, the user, the history of object operations, and/or object attributes associated with the selected system. A user may use menu 62 instead of buttons 56 when, for example, use of a pointing device is not preferred or the user does not desire to reserve display space for buttons 56.

After identifying the user, customization system 36 (FIG. 1) can access the history of object operations performed by the user and determine those object operations that have been most frequently selected by the user. Shortcuts can be displayed for the object operations that have been selected most frequently. For example, if user 26's (FIG. 1) history indicates he/she selects cut and past operations most frequently for object 44A, buttons for those object operations will be displayed in area 54 when object 44A is selected by user 26. The number of shortcuts displayed can be a designated number (e.g., three), and/or can be varied based on the frequencies of the object operations. For example, a threshold amount of selections or percentage of selections can be required before a shortcut is displayed for a particular object operation.

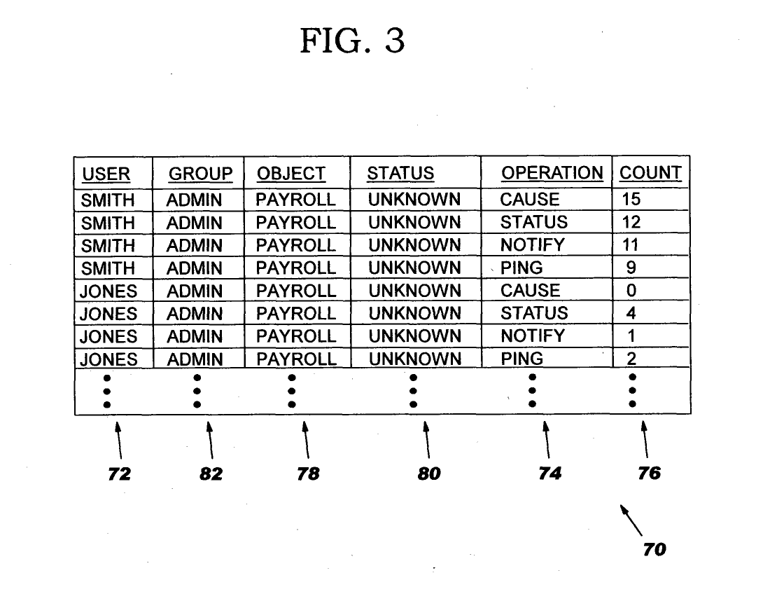

Shortcuts can be displayed based on the user and a history of object operations performed by the user. To this extent, selected object operations can be recorded in the history using recording system 34 (FIG. 1). FIG. 3 depicts a portion of an illustrative history 70 (e.g., that is stored in storage unit 24 shown in FIG. 1). As shown, each entry (e.g., row) includes data fields for a user 72, an object operation 74, and a count 76. Initially, count data field 76 for each entry is set to zero. Each time a user selects an object operation, recording system 34 (FIG. 1) would increment count 76 by one for the entry that corresponds to user 72 and the selected object operation 74. To determine the object operation having the highest frequency for a user, an entry that corresponds to the user and that has the highest value for count 76 is retrieved. The object operation 74 for the retrieved entry has the highest frequency. This process can be repeated for any desired number of shortcuts to display (e.g., second highest, third highest, etc.). When multiple shortcuts are displayed, the shortcuts can be displayed in descending order of frequency.

Further, each entry can include a data field for an object 78 for which object operation 74 was selected by user 72. In this case, to determine the shortcuts to be displayed, entries having both the user 72 and selected object 78 are located, and a shortcut is displayed for the object operation 74 that has been selected most frequently by the particular user. For example, when Smith is the user, and the Payroll object is selected, only entries in which user 72 is “Smith” and object 78 is “Payroll” would be used to determine the shortcuts to be displayed. Still further, an object may have a plurality of object states. Shortcuts can be displayed based on the object state of the object. For example, an object may have a read only or read/write state. Shortcuts for object operations that require a read/write state would not be displayed when the object has a read only state. Further, each object 44A-E (FIG. 2) can have object states based on one or more object attributes. For example, status object attribute 50 (FIG. 2) can have unknown, active, or inactive states. Each entry in history 70 can further include a status 80 data field. Including status 80 further allows the displayed shortcut to be based on the status object attribute 50 (FIG. 2) of a selected object. For example, a set of objects that have status 80 of “unknown” could be used to determine a shortcut to be displayed.

User 26 (FIG. 1) can also have one or more user attributes. The user attributes may be used to determine which shortcut is most likely by using entries for a set of users having the same user attribute. For example, each entry in history 70 is shown including a data field for group 82. When user 26 is identified and an object is selected, customization system 36 (FIG. 1) can use object operation selections by all users in the same group 82 to determine the shortcut(s) to be displayed for user 26. User attributes may also be used to eliminate certain object operations from being available. For example, “Smith” may have recently changed job titles from operator to administrator. While an operator, Smith may have frequently selected the “Ping” object operation. However, now that Smith is an administrator, Smith may no longer have access to select “Ping.” As a result, the shortcut for the ping object operation would not be displayed.

Additional information can be used to determine the shortcut(s) to be displayed. For example, user interface system-28 (FIG. 1) is commonly activated by or implemented as part of an application 38 (FIG. 1) that manages the object (e.g., read, write, save, etc.). Shortcuts can be displayed based on the application that is managing the object. For example, FIG. 2 shows a display area 42 that comprises a spreadsheet. Display area 42 could be activated by a spreadsheet application, a browser application, etc. A user may be allowed to perform any object operation when display area 42 is activated by a spreadsheet application, while only a subset of object operations may be available when display area 42 is activated by a browser application. As a result, when the user can not access a frequently selected object operation, the shortcut for the object operation is not displayed.

It is understood that numerous variations are possible. For example, some or all of the fields shown in the illustrative entries in FIG. 3 could be stored in separate entries. Further, rather than using a count 76 as shown in FIG. 3, a new entry can be added by recording system 34 (FIG. 1) each time a user selects an object operation. To determine the frequency for a desired combination of data fields, the quantity of entries in the database would be determined. While this solution requires additional database entries, additional flexibility can be incorporated. For example, a timestamp field can also be included with each entry. Entries that correspond to selections that occurred a selected amount of time in the past can be purged from the database. As a result, the frequency would only consider object operation selections that occurred within a recent time period. Additionally, shortcuts can be altered based on a previously selected object operation. For example, a user may frequently select to print a document immediately after saving the document. The timestamp field can be used to determine the order of previous object operation selections. As a result, once the user selects the save operation, a shortcut for the print operation could be displayed.

Further, only a subset of available object operations and/or user attributes may be recorded by recording system 34 (FIG. 1). For example, each system 44A-E shown in FIG. 2 includes a type attribute 52. The value for type attribute 52 might be eliminated from and/or not included in history 70 (FIG. 3) if it is determined that variations in values for type attribute 52 do not impact the selected object operations. This functionality could be implemented as part of a “smart” solution that automatically analyzes history 70 for various patterns in object operation selections. Additionally, operations selected from help menu 63 may not be recorded. These selections are generally made when a user is learning how to use user interface 40. Still yet, a different algorithm for displaying shortcuts can be used when a user has not reached a threshold number of selected object operations. For example, the entries for the “Jones” user shown in FIG. 3 indicate the he/she has not selected very many object operations (e.g., a total of seven). As a result, the selections for Jones may be combined with other users having the same group 82 to determine the shortcuts to be displayed. It is understood that numerous algorithms can be used to select the shortcuts for display.

While the illustrative embodiment of the invention determines shortcut(s) for display based on a user's selections and/or additional attributes, it is understood that numerous combinations of attributes and/or selections is possible. In particular, any combination of the object, object attribute(s), object state(s), application, user, user attribute(s), and/or selection history can be used to select the object operations for which to display shortcuts.

It is understood that the present invention can be realized in hardware, software, or a combination of hardware and software. Any kind of computer/server system(s)—or other apparatus adapted for carrying out the methods described herein—is suited. A typical combination of hardware and software could be a general-purpose computer system with a computer program that, when loaded and executed, carries out the respective methods described herein. Alternatively, a specific use computer, containing specialized hardware for carrying out one or more of the functional tasks of the invention, could be utilized. The present invention can also be embedded in a computer program product, which comprises all the respective features enabling the implementation of the methods described herein, and which—when loaded in a computer system—is able to carry out these methods. Computer program, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of various embodiments of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

1. A method of customizing a user interface, the method comprising:
identifying a user of the user interface;
displaying an object within the user interface; and
displaying a shortcut for the object based on the user and a history of object operations performed by the user.

2. The method of claim 1, wherein the shortcut comprises one of: a hyperlink, a button, an icon, a toolbar control, and a menu item.

3. The method of claim 1, wherein the object comprises one of a data file and a set of related data within a data file.

4. The method of claim 1, further comprising recording object operations that are performed by the user on the object to create the history of object operations.

5. The method of claim 4, wherein the displaying step includes:
calculating a frequency that each object operation was selected by the user using the history of object operations;
determining a particular object operation having the highest frequency for the user; and
displaying the shortcut for the determined object operation.

6. The method of claim 1, further comprising managing the object using an application, wherein the displayed shortcut is further based on the application.

7. The method of claim 1, wherein the object has one of a plurality of object states, and wherein the displayed shortcut is further based on the object state.

8. The method of claim 1, wherein the user has a user attribute, and wherein the displayed shortcut is further based on a history of object operations selected by a set of users having the user attribute.

9. The method of claim 1, wherein the object has an object attribute, and wherein the displayed shortcut is further based on a history of object operations selected for a set of objects having the object attribute.

10. The method of claim 1, further comprising reserving a portion of a display area of the user interface for displaying the shortcut, wherein the shortcut is displayed in the reserved portion.

11. A method of customizing a user interface, the method comprising:
identifying a user of the user interface;
displaying an object within the user interface, wherein the object has an object attribute;
recording object operations that are performed by the user on the object in a history of object operations; and
displaying a shortcut for the object based on the user, the object attribute, and the history of object operations.

12. The method of claim 11, further comprising managing the object using an application, wherein the displayed shortcut is further based on the application.

13. The method of claim 12, further comprising:
reserving a portion of a display area of the user interface for displaying the shortcut, wherein the shortcut is displayed in the reserved portion.

14. A system for customizing a user interface, the system comprising:
an identification system for identifying a user of the user interface;
a display system for displaying an object in the user interface;
a recording system for recording object operations that are selected by the user; and
a customization system for displaying a shortcut for an object operation based on the recorded object operations and the object.

15. The system of claim 14, further comprising an application for managing the object and the user interface.

16. The system of claim 15, wherein the displayed shortcut is further based on the application.

17. The system of claim 14, wherein the object has one of a plurality of object states, and wherein the displayed shortcut is further based on the object state.

18. The system of claim 14, wherein the user has a user attribute, and wherein the displayed shortcut is further based on the recorded object operations selected by a set of users having the user attribute.

19. The system of claim 14, wherein the object has an object attribute, and wherein the displayed shortcut is further based on the recorded object operations selected for a set of objects having the object attribute.

20. A program product stored on a recordable medium for customizing a user interface, which when executed comprises:
program code for identifying a user of the user interface;
program code for displaying an object in the user interface;
program code for recording object operations that are selected by the user; and
program code for displaying a shortcut for an object operation based on the recorded object operations and the user.

21. The program product of claim 20, further comprising program code for managing the object and the user interface.

22. The program product of claim 21, wherein the displayed shortcut is further based on the program code for managing.

23. The program product of claim 20, wherein the object has one of a plurality of object states, and wherein the displayed shortcut is further based on the object state.

24. The program product of claim 20, wherein the user has a user attribute, and wherein the displayed shortcut is further based on the recorded object operations selected by a set of users having the user attribute.

25. The program product of claim 20, wherein the object has an object attribute, and wherein the displayed shortcut is further based on the recorded object operations selected for a set of objects having the object attribute.
